(19) United States
(12) Patent Application Publication
(10) Pub. No.: US 2022/0321737 A1
(43) Pub. Date: Oct. 6, 2022

(54) SYSTEM FOR DATA SECLUSION IN IMAGE AND AUDIO FILES

(71) Applicants: Romany Fouad Mansour, El-Kharga (EG); José Escorcia-Gutierrez, Barranquilla (CO); Margarita Gamarra, Barranquilla (CO); Adnen El Amraoui, Arras (FR); Fayadh Alenezi, Sakaka (SA); Sara Althubiti, Al-Majmaah (SA); Vivek Kumar, Mandawar (IN); S. B. Chordiya, Pune (IN); Narbada Devi, Mandi (IN); Biplab Kumar Sarkar, Bengaluru (IN)

(72) Inventors: Romany Fouad Mansour, El-Kharga (EG); José Escorcia-Gutierrez, Barranquilla (CO); Margarita Gamarra, Barranquilla (CO); Adnen El Amraoui, Arras (FR); Fayadh Alenezi, Sakaka (SA); Sara Althubiti, Al-Majmaah (SA); Vivek Kumar, Mandawar (IN); S. B. Chordiya, Pune (IN); Narbada Devi, Mandi (IN); Biplab Kumar Sarkar, Bengaluru (IN)

(21) Appl. No.: 17/806,563

(22) Filed: Jun. 13, 2022

(51) Int. Cl. H04N 1/44; H04N 1/32; H04N 1/327

(52) U.S. Cl. CPC H04N 1/4486; H04N 1/3216; H04N 1/32797; H04N 2201/3281

(57) ABSTRACT

The present disclosure generally relates to a system for data seclusion in image & audio files comprises a data processing unit for receiving input signals and converting into digitized image and audio data; a compressor unit for reducing size of the digitized image and audio data using a j-bit encoding at a variable rate; an encryption unit for encrypting the compressed digitized image and audio data using an advanced encryption standard (AES); a control unit for stripping the encrypted compressed digitized image and audio data into a plurality of portions, wherein the control unit generates a cryptographic key for decrypting every encrypted image and audio data; and a blockchain database configured with a cloud server for receiving the portions of the encrypted compressed digitized image and audio data and proportionately storing the portions of the encrypted compressed digitized image and audio data onto a plurality of storage media.

### TECHNICAL FIELD

The present disclosure relates to digital signal processing systems, in more details, a system for data seclusion in image & audio files.

### BACKGROUND

The process of transforming data from its raw, siloed, and normalised source state into data that is brought together, dimensionally modelled, de-normalized, and suitable for analysis is known as data transformation. Data transformation may be time-consuming, costly, and laborious without the correct technological stack in place. However, converting your data will assure optimum data quality, which is critical for correct analysis and, ultimately, meaningful insights that will enable data-driven choices.

Building and training models to interpret data is a fantastic idea, and more businesses are using or planning to use machine learning to handle a variety of practical applications. However, in order for models to learn from data and produce useful predictions, the data must be arranged so that analysis yields useful results. In the view of the forgoing discussion, it is clearly portrayed that there is a need to have a system for data seclusion in image & audio files.

### BRIEF SUMMARY

The present disclosure seeks to provide a system for the encoding and storage of signals representing image and audio information onto a plurality of storage media for data security.

In an embodiment, a system for data seclusion in image & audio files is disclosed. The system includes a data processing unit for receiving input signals and converting into digitized image and audio data. The system further includes a compressor unit for reducing size of the digitized image and audio data using a j-bit encoding at a variable rate. The system further includes an encryption unit for encrypting the compressed digitized image and audio data using an advanced encryption standard (AES). The system further includes a control unit for stripping the encrypted compressed digitized image and audio data into a plurality of portions, wherein the control unit generates a cryptographic key for decrypting every encrypted image and audio data. The system further includes a blockchain database configured with a cloud server for receiving the portions of the encrypted compressed digitized image and audio data and proportionately storing the portions of the encrypted compressed digitized image and audio data onto a plurality of storage media.

In another embodiment, the portions of the image and audio data are stored in a discontinuous manner independent of each other.

In another embodiment, the encrypted compressed digitized image data forms one or more image programs and the encrypted compressed digitized audio data forms one or more audio programs.

In another embodiment, the system comprises an identifier configured to link the compressor to one or more audio programs with one or more image programs.

In another embodiment, the cloud server is coupled to the control unit for providing parallel striping information such that stored portions of the image and audio data is retrieved at a user defined data transfer rate to promote error protection redundancy.

In another embodiment, the system comprises a data pre-processing unit for normalizing images upon dividing the value of each pixel by 255 to obtain a new matrix in the value domain from 0 to 1.

In another embodiment, the data pre-processing unit further normalizing raw audio data and reshaping to a new 3D matrix of the same shape as three-color channels image thereby applying short-time Fourier transform (STFT) to transform audio to the frequency domain to generate 3D matrix data with two channel.

An object of the present disclosure is to promote digital data security.

Another object of the present disclosure is to provide encoding, encryption, storage, and management of digital image and audio data.

Yet another object of the present disclosure is to deliver an expeditious and cost-effective system for data seclusion in image & audio files.

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a system for data seclusion in image & audio files in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying drawings.

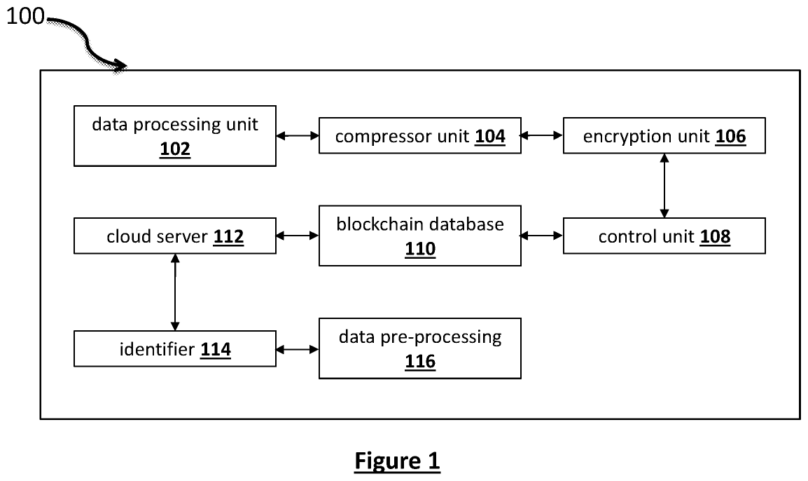

Referring to FIG. 1, a block diagram of a system for data seclusion in image & audio files is illustrated in accordance with an embodiment of the present disclosure. The system 100 includes a data processing unit 102 for receiving input signals and converting into digitized image and audio data. The signal is digitally scanned at a high resolution to generate digitized version of the motion picture or other program.

In an embodiment, a compressor unit 104 is connected to the data processing unit 102 for receiving digitized image and audio data thereby reducing size of the digitized image and audio data using a j-bit encoding at a variable rate.

In an embodiment, an encryption unit 106 is connected to the compressor unit 104 for encrypting the compressed digitized image and audio data using an advanced encryption standard (AES).

In an embodiment, a control unit 108 is connected to the encryption unit 106 for stripping the encrypted compressed digitized image and audio data into a plurality of portions, wherein the control unit 108 generates a cryptographic key for decrypting every encrypted image and audio data.

In an embodiment, a blockchain database 110 is configured with a cloud server 112 and connected to the control unit 108 for receiving the portions of the encrypted compressed digitized image and audio data and proportionately storing the portions of the encrypted compressed digitized image and audio data onto a plurality of storage media. The storage media include multiple magnetic storage media, wherein image and audio data are stored non-sequentially on the multiple magnetic storage media.

In another embodiment, the portions of the image and audio data are stored in a discontinuous manner independent of each other.

In another embodiment, the encrypted compressed digitized image data forms one or more image programs and the encrypted compressed digitized audio data forms one or more audio programs.

In another embodiment, the system comprises an identifier 114 configured to link the compressor to one or more audio programs with one or more image programs.

In another embodiment, the cloud server 112 is coupled to the control unit 108 for providing parallel striping information such that stored portions of the image and audio data is retrieved at a user defined data transfer rate to promote error protection redundancy.

In another embodiment, the system comprises a data pre-processing unit 116 for normalizing images upon dividing the value of each pixel by 255 to obtain a new matrix in the value domain from 0 to 1.

In another embodiment, the data pre-processing unit 116 further normalizing raw audio data and reshaping to a new 3D matrix of the same shape as three-color channels image thereby applying short-time Fourier transform (STFT) to transform audio to the frequency domain to generate 3D matrix data with two channel.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for data seclusion in image and audio files, comprising:
a data processing unit for receiving input signals and converting into digitized image and audio data;
a compressor unit for reducing size of said digitized image and audio data using a j-bit encoding at a variable rate;
an encryption unit for encrypting said compressed digitized image and audio data using an advanced encryption standard (AES);
a control unit for stripping said encrypted compressed digitized image and audio data into a plurality of portions, wherein said control unit generates a cryptographic key for decrypting every encrypted image and audio data; and
a blockchain database configured with a cloud server for receiving said portions of said encrypted compressed digitized image and audio data and proportionately storing said portions of said encrypted compressed digitized image and audio data onto a plurality of storage media.

2. The system of claim 1, wherein said portions of said image and audio data are stored in a discontinuous manner independent of each other.

3. The system of claim 1, wherein said encrypted compressed digitized image data forms one or more image programs and said encrypted compressed digitized audio data forms one or more audio programs.

4. The system of claim 1, wherein said system comprises an identifier configured to link said compressor to one or more audio programs with one or more image programs.

5. The system of claim 1, wherein said cloud server is coupled to said control unit for providing parallel striping information such that stored portions of said image and audio data is retrieved at a user defined data transfer rate to promote error protection redundancy.

6. The system of claim 1, wherein said system comprises a data pre-processing unit for normalizing images upon dividing said value of each pixel by 255 to obtain a new matrix in said value domain from 0 to 1.

7. The system of claim 1, wherein said data pre-processing unit further normalizing raw audio data and reshaping to a new 3D matrix of said same shape as three-color channels image thereby applying short-time Fourier transform (STFT) to transform audio to said frequency domain to generate 3D matrix data with two channel.
